(19) United States
(12) Patent Application Publication
(10) Pub. No.: US 2012/0189755 A1
(43) Pub. Date: Jul. 26, 2012

(54) PIG-FAT SUBSTITUTE BASED ON VEGETABLE FAT AND METHOD FOR OBTAINING SAME

(75) Inventors: Adriana Fernanda Cruz Serna, Bogota (CO); Juan Camilo Ospina Echeverri, Bogota (CO)

(73) Assignees: Industria de Alimentos Zenu S.A.S.; Teams Foods Colombia S.A.

(21) Appl. No.: 13/265,648

(22) PCT Filed: Apr. 22, 2010
(86) PCT No.: PCT/IB10/00896

§ 371 Date: Jan. 17, 2012

(30) Foreign Application Priority Data
Apr. 24, 2009 (CO) 09041670

(51) Int. Cl. A23D 9/00; A23L 1/314; A21D 13/08; A23L 1/317; A23L 1/31; A21D 13/00

(52) U.S. Cl. 426/607; 426/641; 426/549; 426/556; 426/560; 426/646; 426/645

(57) ABSTRACT

The present invention relates to the production of pig-fat substitutes that comprise a mixture of at least two of the following oils: palm oil and at least one of the following polyunsaturated and/or monounsaturated oils, namely sunflower and/or safflower oil, canola, soya, olive and high oleic sunflower and/or high oleic safflower oil. This substitute can be used in meat and bakery products.

### FIELD OF THE INVENTION

The present invention relates to the manufacture of substitutes for fat of animal origin, especially pig feed for application in the food industry, by fats of vegetable origin with nutritional benefits in the reduction of saturated fatty acids, low in trans acid and with content of omega 3 fatty acids (ALA, alpha-linolenic acid), oriented to the meat and bakery industry.

### ANTECEDENTS OF THE INVENTION

At present, the products manufactured for the meat industry, such as hot dogs, salamis, hamburgers and every kind of sausage, are made from pig, beef and poultry meat, incorporating a percentage of animal fat that gives the product some of its functional and sensory characteristics.

It is well known that this type of fat of animal origin contains certain proportions of saturated fatty acids, trans fatty acids and cholesterol, which when consumed in excess are harmful to the health.

In this regard, various studies have been carried out for the replacement of this animal fat by other sources of fats of vegetable origin, trying to achieve the same functionality.

In the U.S. Pat. No. 1,446,004 of Ellis, reference is made to an animal fat substitute that consists in hydrogenating up to 80% saturation coconut and palm oils, mixed with another proportion of liquid oils coming from peanut or Brazil nuts to obtain a product with characteristics similar to said fat. This is a partially hydrogenated product that is not free of trans fatty acids. It is likewise known that coconut and palm oils have a high content of saturated fatty acids, so that this product does not have benefits in the area of health and nutrition.

In the study published by Ambrosiadis, J., et al., in the International Journal Foodscience Technology (1996), tests were carried out with oils of vegetable origin (soy, sunflower, cottonseed and corn) for fat substitution in beef hot dogs and salami, showing a good stability of the emulsion but with some drawbacks in terms of firmness, luminosity, and color of the finished product.

In the article published by Tan, S. S., et al., entitled “Chemical, physical and sensory properties of chicken frankfurters substituted with palm fats” (International Journal Food Science Nutrition Vol. 52 of 2001), reference is made to the use of palm oils in fat substitution for chicken hot dogs, obtaining significant changes in regard to the color (red, yellow) and luminosity of the finished product.

In the article entitled “replacement of lard with vegetable fat in hot dogs” of Rueda et al., it mentions the incorporation of avocado paste to which are added two inhibitors to prevent the enzymatic darkening of the end product. In this work, the incorporation of avocado oil was done as vegetable fat making up the system of protein and fat emulsion; even so, there were some differences in regard to luminosity with respect to the control samples. Even though there was a certain level of acceptance (50%) on the part of the consumer, some of the sensory characteristics (green color and less shine/luminosity) that are standard in this type of product were modified.

In the article entitled “Utilization of interesterified oil blends in the production of frankfurters” by Emin Öxvural and Halil Vural, 2008, a study is presented whose objective is the replacement of beef fat for meat products with mixtures of interesterified vegetable oils. The results obtained in the different treatments show some profiles closes to the profile of the animal fat with some reductions in the level of near 10% saturated fats. Even so, this study did not incorporate omega 3 fatty acids in the final composition, nor does it make reference to the low contents of trans fatty acids in the products, besides the clear fact that this work was done on the basis of beef fat, and not pig fat, as in the present invention.

The international publication WO2008/047012 A2 of Gaud and Alfos presents an invention relating to an animal fat substitute based on palm oils and their partially hydrogenated fractions in mixture with other oils of vegetable origin (rapeseed, olive, corn, soy and sesame oil), but with trans levels between 4% and 7%, which makes it a less healthy product than that developed by the present invention.

Furthermore, the application of pig fat in bakery products is known, such as puff pastries, cookies and cakes, in which this fat has had good acceptance.

### BRIEF SUMMARY OF THE INVENTION

The present invention relates to a pig fat substitute which is obtained from palm oil products and its fractions, optionally hydrogenated to the full extent, and mono-unsaturated and/or polyunsaturated oils (canola oil, sunflower and/or safflower oil, high oleic sunflower and/or high oleic safflower oil, soy oil, olive oil) which are subsequently modified chemically by interesterification to obtain a product with melting and solids curve profile similar to pig fat with lower contents of saturated fatty acids between 30 and 40%, content of trans fatty acids less than 2%, free of cholesterol, and with presence of omega 3 fatty acids (ALA, alpha-linolenic acid), having a nutritional benefit with respect to the products existing on the market.

The present invention provides a fat base of vegetable origin of better nutritional value than pig fat with very good performance for the manufacture of sausage products, in that its behavior with the other basic meat components of bovine and poultry origin, modified starches, protein concentrates, salts and spices, exhibits an excellent incorporation and emulsification, as well as certain sensory characteristics of the end product in keeping with what is required for this type of product, such as juiciness, luminosity, texture, color, taste and odor.

Additional objectives and benefits of the present invention shall become more evident in the description of the tables, the detailed specification of the invention and the claims.

The present invention also has application in bakeries, where the pig fat substitute presents functional advantages similar to those obtained with the use of pig lard. The use of this product thus far shows an adequate performance in the bakery industry.

### DETAILED SPECIFICATION OF THE INVENTION

The purpose of the present invention is to obtain a fat product that has a lower quantity of saturated fat than that of a fat coming from pig lard, omega 3 fatty acids, and a low level of trans fatty acids, good organoleptic properties and functional performance similar to that of a fat base of porcine origin, enabling its use as an ingredient in the sausage industry in products such as hot dogs, salami, and other products of the meat industry where lard is used.

The pig fat substitute of the present invention is characterized in having in its composition a mixture of oils of medium saturation, such as palm oil and its fractions, optionally hydrogenated without formation of trans fatty acids, in which reaction they are in a range of 10% to 50%, preferably between 20% and 40% and more preferably between 25% and 35%; with monounsaturated and/or polyunsaturated oils of type canola oil, sunflower and/or safflower oil, high oleic sunflower oil and/or high oleic safflower oil, soy oil, olive oil, which can be in a range of 50% to 90%, preferably between 60% and 80% and more preferably between 65% and 75%, these can be subsequently modified chemically by the process of interesterification or not.

This fat base is characterized in that its chemical composition contains a level of stearic acid C18:0 of 10% to 25%, preferably between 12% and 20% of stearic acid C18:0 and more preferably between 13% and 18% of stearic acid C18:0.

This fat base is also characterized in that its chemical composition contains a level of saturated fatty acids between 30 and 40%, preferably between 32% and 38% and more preferably between 33% and 36%. In addition, this fat base comprises a proportion of omega 3 fatty acids (ALA, alpha-linolenic acid) between 2% and 6% and a content of trans fatty acids less than 2%.

The characteristic curve of the solids profile of this fat base, using the IUPAC 2.150a method, is between the following ranges: 10° C. between 10% and 30%; at 20° C. between 5% and 20%; at 30° C. between 2% and 10%. In addition, the melting point of this fat base, determined by the AOCS Cc 2-31 method, is between 34 and 39° C.

The fat product of the present invention in its preferred embodiment comprises the following steps:

(a) Fractionation of the palm oil R.B.D. (refined, bleached and deodorized) by a dynamic crystallization at a temperature in the range of 16° C. and 20° C., (b) a second fractionation of the stearin obtained in the preceding stage by a dynamic crystallization at a temperature between 36° C. and 46° C.;
(c) Hydrogenation to total saturation of the palm oil in a pressurized reactor with hydrogen atmosphere at a pressure between 68, 95 and 137.9 kPa (10-20 psi) and a temperature between 160° C. and 180° C. with addition of nickel catalyst in a proportion of 0.1 and 0.4% until obtaining an iodine index less than 2, after which the oil is filtered and bleached.

Mixing of the palm oils obtained in the previous stages (a) and/or (b) and/or (c) with adding of oils low in saturated and high in polyunsaturated and/or monounsaturated fatty acids.

Redistribution of the fatty acids in the triglycerides of the mixture by the process of interesterification, generating a change in the melting characteristics, solids profile, and crystallization that are adequate for the purpose of the invention.

Filtration of the catalyst and the subproducts, refining, bleaching and deodorization of the interesterified mixture to obtain the end product R.B.D. (refined, bleached and deodorized).

Crystallization and packing of the product in a scraped surface heat exchanger.

It has been found that the product of the invention is very adequate as raw material for the making of food products such as hot dogs, sausages, salami, and every kind of product of the meat industry.

Examples of the fat bases are given below, illustrating the characteristics of the invention.

### Example 1

(1) Palm oil R.B.D. was taken and subjected to a fractionation process in a dynamic crystallizer with agitation until reaching an end temperature of 18° C. and it was then filtered, separating the olein and stearin obtained, each in a different tank. The stearin was then subjected once more to a fractionation process in a dynamic crystallizer with agitation at an end temperature of 44° C., after which it was filtered, again separating the olein and the stearin in different tanks, this latter stearin being used for the mixture of the example.
(2) Palm oil R.B.D. was taken and hydrogenated to final saturation with an iodine index less than 2, after which the catalyst was filtered from the product and the resulting fat was bleached.
(3) After this, a mixture of the final stearin was made
   (1) with the completely hydrogenated oil (2) and the addition of canola oil R.B.D. and sunflower oil R.B.D. in the following proportions:
   (1) 12%
   (2) 15%

### Canola oil 33%

### Sunflower oil 40%

This mixture was subjected to randomization of fatty acids by a chemical interesterification reaction with addition of sodium methoxide as catalyst at 0.2%, then the reaction was neutralized and the bleaching, refining and deodorization of this fat was carried out.
Finally, the refined product was subjected to the process of crystallization in a scraped surface heat exchanger, to be packed in boxes.

The results are shown in table 1.1 below

TABLE 1.1
Result of the fat base of Example 1

| PHYSICOCHEMICAL ANALYSIS | RESULTS |
|---|---|
| Melting point, ° C. | 37.7 |
| Solid Fat Content, SFC | |
| N10 | 17.1 |
| N20 | 9.6 |
| N25 | 7.4 |
| N30 | 4.6 |
| N35 | 2.8 |
| N40 | 0 |
| | Percentage, % |
| C12:0 lauric acid | 0.2 |
| C14:0 myristic acid | 0.4 |
| C16:0 palmitic acid | 19.1 |
| C18:0 stearic acid | 13.2 |
| C18:1 oleic acid | 33.2 |
| C18:1 trans | 0 |
| C18:2 linoleic acid | 29.4 |
| C18:2 trans | 0.9 |
| C18:3 linolenic acid (omega 3) | 2.2 |
| C18:3 trans | 0.9 |
| C20:0 | 0.5 |
| C20:1 | 0 |
| Total saturated (SAFA) | 33.4 |
| Total monounsaturated (MUFA) | 33.2 |
| Total polyunsaturated (PUFA) | 33.4 |

### Example 2

(1) Palm oil R.B.D. was taken and hydrogenated to total saturation with an iodine index less than 2, after which the catalyst was filtered from the product and the obtained fat was bleached.
(2) After this, a mixture was made of the completely hydrogenated palm oil (1) at around 30% with the addition of canola oil R.B.D. at around 70%.
This mixture was subjected to a randomization of fatty acids by a chemical interesterification reaction with addition of sodium methoxide as catalyst at 0.2%, then the reaction was neutralized and the bleaching, refining and deodorization of this fat was carried out.
Finally, the refined product was subjected to the process of crystallization in a scraped surface heat exchanger, to be packed in boxes.

The results are shown in table 1.2 below

TABLE 1.2
Result of the fat base of Example 2

| PHYSICOCHEMICAL ANALYSIS | RESULTS |
|---|---|
| Melting point, ° C. | 38.3 |
| Solid Fat Content, SFC | |
| N10 | 21.2 |
| N20 | 11.1 |
| N25 | 7.4 |
| N30 | 4.5 |
| N35 | 2.5 |
| N40 | 0 |
| | Percentage, % |
| C12:0 lauric acid | 0.2 |
| C14:0 myristic acid | 0.4 |
| C16:0 palmitic acid | 16.3 |
| C18:0 stearic acid | 18.3 |
| C18:1 oleic acid | 41.9 |
| C18:1 trans | 0 |
| C18:2 linoleic acid | 15.7 |
| C18:2 trans | 0.5 |
| C18:3 linolenic acid (omega 3) | 4.1 |
| C18:3 trans | 1.2 |
| C20:0 | 0.6 |
| C20:1 | 0.8 |
| Total saturated (SAFA) | 35.8 |
| Total monounsaturated (MUFA) | 42.7 |
| Total polyunsaturated (PUFA) | 21.5 |

### Example 3

With the fat bases of example 1 and 2 above, meat industry applications were carried out with replacement of back bacon in cooked salami, having a percentage of total fat of 27.5%, in order to evaluate different percentages of substitution with 3 repetitions each in regard to the end result of the salami in parameters such as texture, pH, nitrites, appearance, color, odor and taste. The results are presented in table 1.3.

| | | | | | | | |
|---|---|---|---|---|---|---|---|
| BACON | 6.0 | ++ | Normal | Colorless | Greasy | Greasy | Masuda |
| 50% | 6.1 | +++ | Normal | Colorless | Normal | Taste- | Masuda |
| example 1 | | | | | | less | |
| 75% | 6.1 | ++ | Normal | Colorless | Greasy | Greasy | Masuda |
| example 1 | | | | | | | |
| 100% | 6.0 | ++ | Normal | Colorless | Normal | Taste- | Masuda |
| example 1 | | | | | | less | |
| 50% | 6.0 | +++ | Normal | Colorless | Normal | Taste- | Masuda |
| example 2 | | | | | | less | |
| 100% | 6.0 | +++ | Normal | Colorless | Normal | Taste- | Masuda |
| example 2 | | | | | | less | |
| 75% | 6.0 | ++ | Normal | Colorless | Greasy | Greasy | Masuda |
| example 2 | | | | | | | |
| melted | 6.0 | ++ | Normal | Colorless | Greasy | Greasy | Masuda |
| lard | | | | | | | |

These characteristics show the adequate performance of these fat bases of example 1 and 2 in substitutions between 50% and 100% as compared to the product made with back bacon alone, where even the organoleptic part of residual fats improves in the substitutions.

The variables of hardness and juiciness were also measured in a texture meter, these being quite important in the final product.

TABLE 1.4
Results on hardness and juiciness in tests performed on
the salamis with different degrees of substitution.

| | HARDNESS | JUICINESS |
|---|---|---|
| BACON | 8622 | 2275 |
| 50% example 1 | 8846 | 2343 |
| 75% example 1 | 9146 | 2341 |
| 100% example 1 | 8966 | 2225 |
| 50% example 2 | 9125 | 2307 |
| 75% example 2 | 8586 | 2274 |
| 100% example 2 | 7669 | 2175 |

In both texture characteristics (hardness, juiciness) one observes that the effects of the substitution between 50% and 100% do not show critical departures from the desired characteristics in the end product that significantly affect the quality.

Examples 1 and 2 reproduce the behavior of the back bacon satisfactorily as regards the organoleptic and textural attributes, as well as the other physicochemical parameters required, making it possible to reduce the content of saturated fatty acids contributed by the back bacon for this application and also improving its nutritional value with the presence of omega 3 fatty acids (ALA, alpha-linolenic acid).

### Example 4

An experiment was performed on the making of tortillas in which the fat base used was the pig lard substitute of the present invention. For this purpose, equal portions of corn flour (500 g), table salt (2.5 g), baking powder (2 g) and pig fat substitute (150 g) and hot water (80 g) were used.

The flour, salt and baking powder were mixed, placing the substitute at the center and mixing uniformly with the dough and slowly adding the water until obtaining the soft consistency required for the application. Next, the tortillas were formed, spreading out the portions of dough with a roller. Next they were subjected to cooking to observe the final characteristics of the product.

The texture, the elasticity, the color and the taste of the different tortillas made with the substitute of the present invention were analyzed, observing properties and behavior very similar to those shown by a tortilla made with pig lard.

In a second application, croissants were made by substituting the pig lard of the recipe with the substitute of the invention to determine its performance in this type of product.

We took 1000 g of wheat flour for pastry, 60 g of sugar, 18 g of salt, 25 g of yeast and 180 g of pig lard substitute and 180 g of pastry puff margarine and 360 g of water.

The wheat flour, salt, sugar and water were mixed to obtain the starting dough, which was worked for a period of 15 minutes in a kneading machine. Once the required texture was obtained, the yeast was added and then the pig lard, gradually incorporating it into the paste formed. We then cut out triangles of approximately 50 to 60 g to commence the process of molding, rolling the triangles and spreading them. This procedure was done various times, forming various turns to obtain an adequate product. The croissants were left to ferment for a period of 30 minutes until reaching an increase of approximately three times their volume. Finally, the croissants were baked at a temperature of 190-200° C. for a time of approximately 20 minutes, until the product took on the required golden color.

The obtained products were analyzed sensorially to compare the performance of the product of the invention with the performance of the traditional product, obtaining similar properties and characteristics in regard to formation of layers, texture and taste of the resulting croissant.

It will be obvious to an expert in the field that various substitutions and modifications could be made to the invention described here without leaving the scope or spirit of the invention. The invention described here can be implemented adequately in absence of any element or elements, limitation of limitations not specifically described here. The terms and expressions used are used as terms and expressions of the description and do not claim to limit the invention in any way, but it is acknowledged that various modifications are possible within the scope of the invention. Thus, it should be understood that although the present invention has been illustrated by specific modalities and optional characteristics, modifications and variations of the concepts described herein can be made by a person with average skill in the subject. Such modifications and variations will be considered as falling within the scope of this invention.

Having specified the invention as above, the content of the following claims is declared as its property:

1. Pig fat substitute, characterized in that it comprises a mixture of at least two of the following oils: palm oil and at least one of the following monounsaturated and/or polyunsaturated oils: sunflower and/or safflower, canola, soy, olive, and high oleic sunflower and/or high oleic safflower.

2. The pig fat substitute of claim 1, characterized in that the palm oil can comprise fractions and/or complete hydrogenation.

3. The pig fat substitute of claim 2, characterized in that it comprises palm oil and its fractions with or without complete hydrogenation between 10% and 50%.

4. The pig fat substitute of claim 2, characterized in that it comprises it comprises palm oil and its fractions with or without complete hydrogenation preferably between 20% and 40%.

5. The pig fat substitute of claim 2, characterized in that it comprises it comprises palm oil and its fractions with or without complete hydrogenation more preferably between 25% and 35%.

6. The pig fat substitute according to claim 1, characterized in that it comprises an interesterified mixture of at least two of the following oils: palm oil and at least one of the following monounsaturated and/or polyunsaturated oils: sunflower, safflower, canola, soy, olive, and high oleic sunflower/safflower.

7. The pig fat substitute of claim 1, characterized in that it comprises a mixture of monounsaturated and/or polyunsaturated oils that are in a range between 50% and 90%.

8. The pig fat substitute of claim 1, characterized in that it comprises a mixture of monounsaturated and/or polyunsaturated oils that are preferably in a range between 60% and 80%.

9. The pig fat substitute of claim 1, characterized in that it comprises a mixture of monounsaturated and/or polyunsaturated oils that are more preferably in a range between 65% and 75%.

10. The pig fat substitute of claim 1, characterized in that it comprises a proportion of saturated fatty acids between 30 and 40%.

11. The pig fat substitute of claim 1, characterized in that it preferably comprises a proportion of saturated fatty acids between 32% and 38%.

12. The pig fat substitute of claim 1, characterized in that it more preferably comprises a proportion of saturated fatty between 33% and 36%.

13. The pig fat substitute of claim 1, characterized in that its chemical composition contains a level of stearic acid C18:0 of 10% to 25%, preferably between 12% and 20% of stearic acid C18:0 and more preferably between 13% and 18% of stearic acid C18:0.

14. The pig fat substitute of claim 1, characterized in that it comprises a proportion of omega 3 fatty acids (ALA, alpha-linolenic acid) between 2% and 6%.

15. The pig fat substitute of claim 1, characterized in that it comprises a proportion of trans fatty acids equal to or less than 2%.

16. The pig fat substitute of claim 1, characterized in that it has a solids profile at 10° C. between 10% and 30%; at 20° C. between 5% and 20%; at 30° C. between 2% and 10%, and a melting point between 34 and 39° C.

17. Method for making a pig fat substitute, characterized by the following steps:
(a) fractionation of the palm oil R.B.D. (refined, bleached and deodorized) by a dynamic crystallization at a temperature in the range of 16° C. and 20° C.;
(b) fractionation of the stearin obtained in the preceding stage by a dynamic crystallization at a temperature between 36° C. and 46° C.;
(c) hydrogenation to total saturation of the palm oil in a pressurized reactor with hydrogen atmosphere at a pressure between 68, 95 and 137.9 kPa (10-20 psi) and a temperature between 160° C. and 180° C. with addition of nickel catalyst in a proportion of 0.1 and 0.4%; then finalizing the reaction when an iodine index less than 2 has been obtained, after which the catalyst is filtered and the oil bleached;
d) mixing of the palm oils obtained in the previous stages (a) and/or (b) and/or (c) with adding of polyunsaturated and/or monounsaturated oils;
e) carrying out a process of interesterification, in which the fatty acids are redistributed within the triglycerides of the mixture;
f) filtering, bleaching, refining and deodorization of the interesterified mixture to obtain the product R.B.D. (refined, bleached and deodorized);
g) crystallization and packing of the product in a scraped surface heat exchanger.

18. Use of the pig fat substitute in the making of products of the meat industry where the lard is replaced for the making of sausages such as hot dogs, sausages, salami, ham and bologna.

19. Use of the pig fat substitute in bakery applications, such as cookies, puff pastry, bread, cakes, and tortillas in the making of the aforementioned products.
